(19) United States
(12) Patent Application Publication
(10) Pub. No.: US 2010/0313427 A1
(43) Pub. Date: Dec. 16, 2010

(54) FOLDING KNIFE CONVENIENT TO CARRY

(76) Inventor: Yen-Chuan HSU, San Chung (TW)

Correspondence Address: Muncy, Geissler, Olds & Lowe, PLLC, 4000 Legato Road, Suite 310, FAIRFAX, VA, 22033, US

(21) Appl. No.: 12/483,966

(22) Filed: Jun. 12, 2009

(51) Int. Cl. B26B 3/06

(52) U.S. Cl. 30/161

(57) ABSTRACT

A folding knife convenient to carry comprises a left handle plate and a right handle plate mutually connected via a fixing element, a blade mounted between the left handle plate and the right handle plate through a pivot, and a leaf spring connected to or integrally formed with the left handle plate or the right handle plate, wherein when the blade is in its open position, the leaf spring retrieves its normal position under the blade and presses its head top surface against a rear end of the blade that an angle A is formed between the head top surface of the leaf spring and the vertical cross surface of the blade, and when the blade is in the folded position, the leaf spring is depressed laterally to move to a predetermined space defined between the left or the right handle plate to the blade, wherein an angle B equal to the angle A is formed between the rear end of the blade and the vertical cross surface to make the rear end of the blade meets the head top surface of the leaf spring, and the rear end of the blade has a knurled surface thereon.

### FIELD OF THE INVENTION

The present invention relates to a knife, particularly, to a folding knife convenient to carry.

### DESCRIPTION OF THE PRIOR ART

In a conventional structure of a folding knife, as shown in FIG. 9, it includes a left handle plate a1 and a right handle plate a2 mutually connected via a fixing element, a blade a4 mounted between the left handle plate a1 and the right handle plate a2 through a pivot a3, and a leaf spring a5 connected to or integrally formed with the left handle plate a1 or the right handle plate a2, wherein when the blade a4 is in its open position, the leaf spring a5 retrieves its normal position under the blade a4 and presses its head top surface a51 against a rear end a41 of the blade a4 to make the blade a4 locked in the open position. To avoid the dislocation of the head top surface a51 of the leaf spring a5 and the rear end a41 of the blade a4 that may cause a lock failure of the blade a4 when jolted by external force, the rear end a41 of the blade a4 was processed to shape into a concave arc (as shown in FIG. 10), wherein the cross-section of the concave arc is perpendicular to the knife faces and the lowest points of the concave arc pass the outermost surface of the blade a4 to make the head top surface a51 of the leaf spring a5 enclosed by the concave arc while the head top surface a51 of the leaf spring a5 comes into contact with the rear end a41 of the blade a4, so as to eliminate hidden risks of safety. However, the tool setting of the blade in the processing mentioned above may consume time, and the cutting tools are likely to be damaged during the processing of the concave arc, all these may increase the processing time and cost.

In order to overcome the foregoing shortcomings and problems, after hard research and development, the inventor develops the present invention, and provides a device primarily for the purpose of providing a folding knife convenient to carry without inherent flaws that may cause an accidental lock failure to cause injury to the user when if the blade unexpectedly closes, and to save time for tool setting and cost for cutting tools.

### SUMMARY OF THE INVENTION

The primary object of the present invention is to provide a folding knife convenient to carry having properties of simple processing procedure, saving working hours, increasing life span of cutting tools, and ensuring the elimination of hidden risks of safety of the knife lock failure.

In order to achieve the aforementioned object, the folding knife convenient to carry according to the present invention comprises a left handle plate and a right handle plate mutually connected via a fixing element, a blade mounted between the left handle plate and the right handle plate through a pivot, and a leaf spring connected to or integrally formed with the left handle plate or the right handle plate, wherein when the blade is in its open position, the leaf spring retrieves its normal position under the blade and presses its head top surface against a rear end of the blade that an angle A is formed between the head top surface of the leaf spring and the vertical cross surface of the blade, and when the blade is in the folded position, the leaf spring is depressed laterally to move to a predetermined space defined between the left or the right handle plate to the blade, wherein an angle B equal to the angle A is formed between the rear end of the blade and the vertical cross surface to make the rear end of the blade meets the head top surface of the leaf spring, and the rear end of the blade has a knurled surface thereon.

In a preferred embodiment of the present invention, the head top surface of the leaf spring is formed in a knurled surface.

Advantageously, the knurled surface of the rear end of the blade or the head top surface of the leaf spring is formed in a pattern such as a linear pattern having straight ridges parallel to knife faces, a diamond-shaped pattern, a plurality of regular-dispersed dimples, or a plurality of regular-dispersed projections.

The advantageous effect of the present invention is: the present invention utilizes the features mentioned above to form an angle B, which is equal to the angle A formed between the head top surface of the leaf spring and the vertical cross surface of the blade, between the rear end of the blade and the vertical cross surface, thereby enlarging the contacting area between the head top surface of the leaf spring and the rear end of the blade while the knife is in an open position, and increasing the friction coefficient between the head top surface of the leaf spring and the rear end of the blade by the knurled surface on the rear end of the blade such that the leaf spring will lock the blade more securely in the open position when in use, and eliminate the safety hidden risks of lock failure even if substantial external force is put against the blade. In addition, the processing of an angle B between the head top surface of the leaf spring and the rear end of the blade is simple that merely needs a milling cutter having optimum geometry structure in the manufacturing line. During the knurling procedure, a knurling cutter is required after the milling procedure, wherein the knurling cutter is more durable than conventional cutting tools for concave arc and the knurling processing is simpler than the processing for concave arc, so as to increase the productivity and reduce the manufacturing cost.

These and other advantages, aspects and novel features of the present invention, as well as details of an illustrated embodiment thereof, will be more fully understood from the following description and drawings.

Other features and advantages of the folding knife convenient to carry according to the present invention will become apparent from the following detailed description of the invention made with reference to the accompanying drawings.

### BRIEF DESCRIPTION OF THE DRAWINGS

FIG. 1 is an assembled perspective view of a folding knife convenient to carry according to the present invention with the blade thereof in an open position.

FIG. 2 is an exploded perspective view of a folding knife convenient to carry according to the present invention with the blade thereof in an open position.

FIG. 3 is an exploded perspective view of a folding knife convenient to carry according to another embodiment of the present invention with the blade thereof in an open position.

FIG. 4 is a side view of the folding knife of FIG. 2 along the P-P lines.

FIG. 5 is an enlarged and partially perspective view of the folding knife of FIG. 1 showing the D part thereof.

FIG. 6 is an enlarged and partially perspective view of the folding knife of FIG. 2 showing the M part thereof.

FIG. 7 is a side view of the folding knife of FIG. 4 along the N-N lines.

FIG. 8 is a side view of the folding knife of FIG. 3 along the E line showing the leaf spring 5 thereof.

FIG. 9 is an assembled perspective view of a conventional folding knife with the blade thereof in an open position.

FIG. 10 is an enlarged and partially perspective view of FIG. 9 showing the C part thereof.

### DETAILED DESCRIPTION

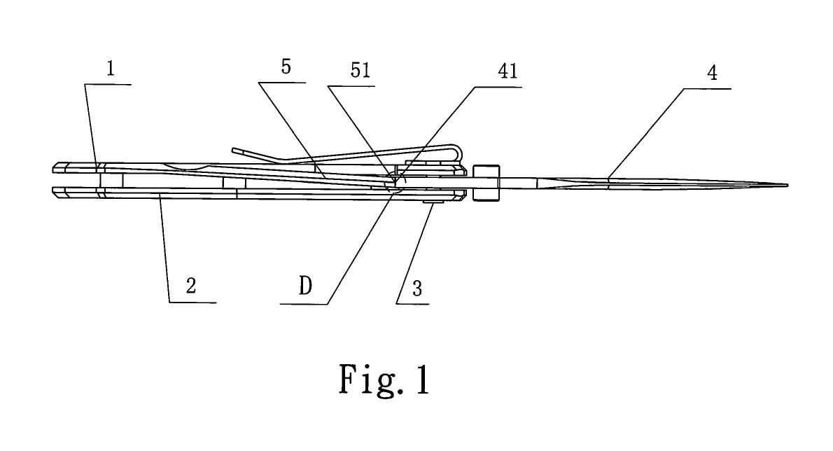

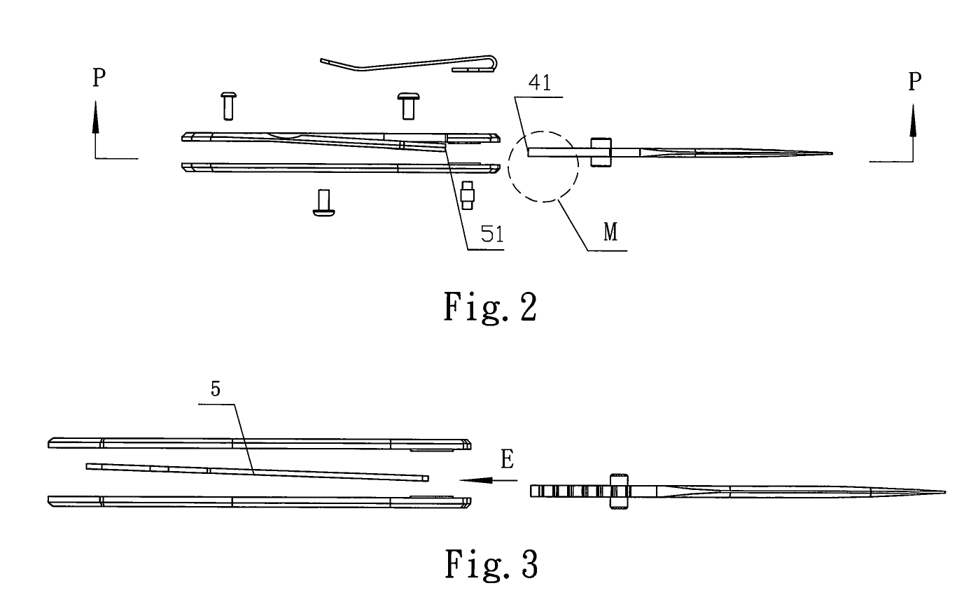

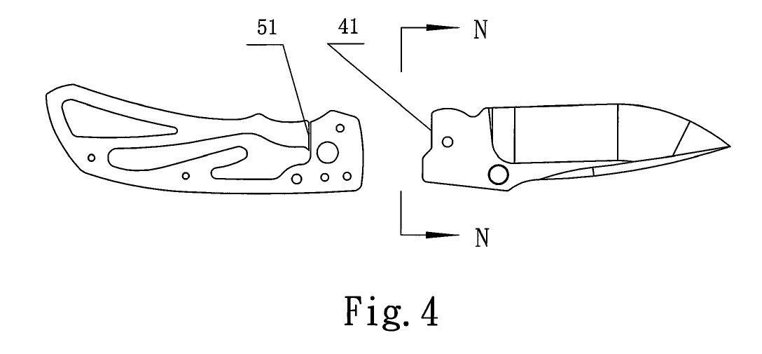

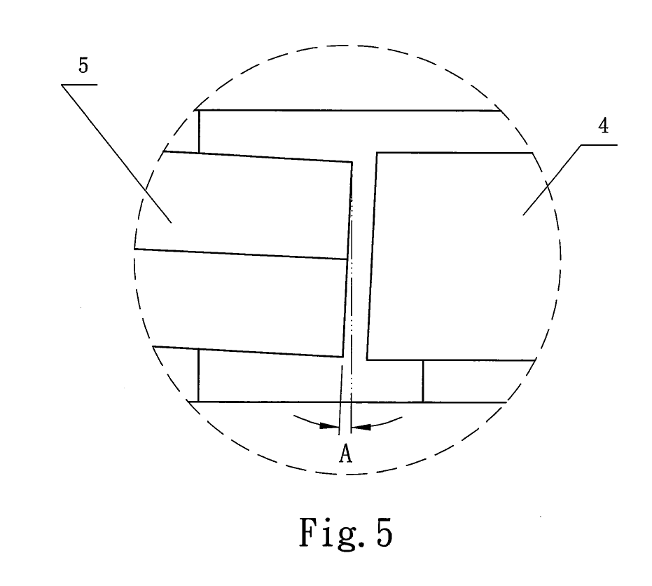

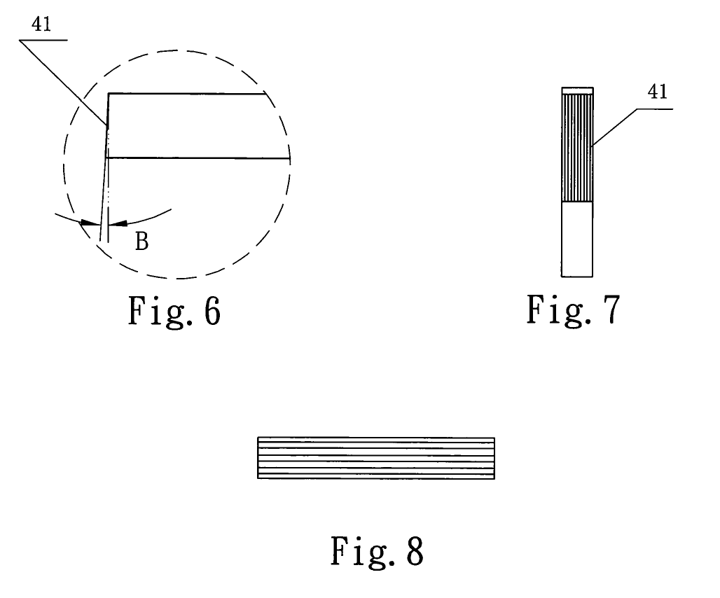

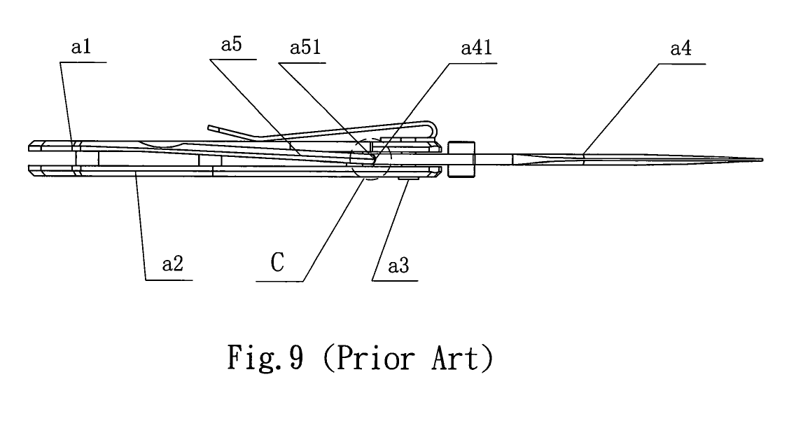

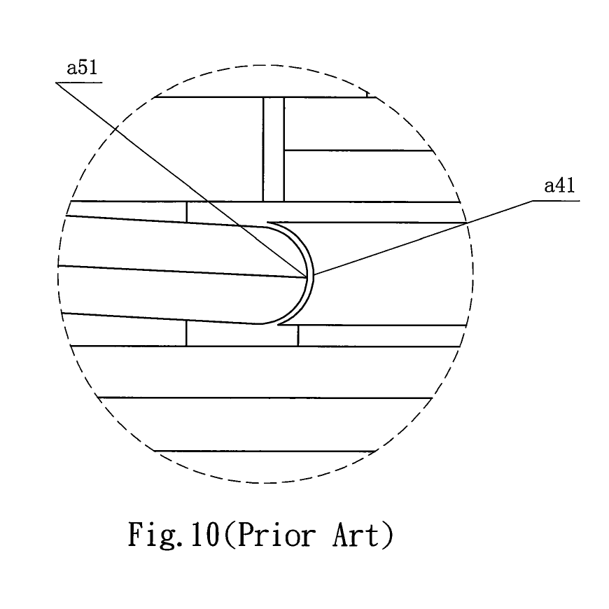

Referring to FIGS. 1-7, the folding knife convenient to carry according to the present invention comprises a left handle plate 1 and a right handle plate 2 mutually connected via a fixing element, a blade 4 mounted between the left handle plate 1 and the right handle plate 2 through a pivot 3, and a leaf spring 5 connected to or integrally formed with the left handle plate I or the right handle plate 2, wherein when the blade 4 is in its open position, the leaf spring 5 retrieves its normal position under the blade 4 and presses its head top surface 51 against a rear end 41 of the blade 4 that an angle A is formed between the head top surface 51 of the leaf spring 5 and the vertical cross surface of the blade 4 (as shown in FIG. 5), such that when the blade 4 is in the folded position, the leaf spring 5 can be depressed laterally to move to a predetermined space defined between the left or the right handle plate 1,2 to the blade 4. Further, as shown in FIG. 6, an angle B equal to the angle A is formed between the rear end 41 of the blade 4 and the vertical cross surface to make the rear end 41 of the blade 4 meets the head top surface 51 of the leaf spring 5, and the rear end 41 of the blade 4 has a knurled surface thereon (as shown in FIG. 7).

As shown in FIG. 3, firstly the processing procedure is to cut off a plate with its peripheral cross sections perpendicular to the surfaces of the plate, such that when one end of the leaf spring 5 is fixed on the handle plate, the plate is bent and inclines to the blade 4 for the other end of the plate to move to the position under the rear end 41 of the blade 4, thereby forming an angle A between the head top surface 51 of the leaf spring 5 and the vertical cross surface of the blade 4. As the rear end 41 of the blade 4 is processed to form the angle B between the rear end 41 of the blade 4 and the vertical cross surface, the head top surface 51 of the leaf spring 5 can meet the rear end 41 of the blade 4 more closely when in contact with each other and thereby enlarge the contacting area between the rear end 41 of the blade 4 and the head top surface 51 of the leaf spring 5 while the knife is in the open position.

As shown in FIG. 8, the head top surface 51 of the leaf spring 5 is advantageously formed in a knurled surface.

As shown in FIG. 7, the knurled surface of the rear end 41 of the blade 4 is preferably formed in a linear pattern having straight ridges parallel to knife faces.

In other preferred embodiments, the pattern of the knurled surface on the rear end 41 of the blade 4 or the head top surface 51 of the leaf spring 5 is a diamond-shaped pattern, a plurality of regular-dispersed dimples, or a plurality of regular-dispersed projections.

While the present invention has been described with reference to certain embodiments, it will be understood by those skilled in the art that various changes may be made and equivalents may be substitutes without departing from the scope of the present invention. In addition, many modifications may be made to adapt a particular situation or material to the teachings of the present invention without departing its scope. Therefore, it is intended that the present invention not be limited to the particular embodiment disclosed, but that the present invention will include all embodiments falling within the scope of the appended claims.

It should be understood that different modifications and variations could be made from the disclosures of the present invention by the people familiar in the art without departing the spirit of the present invention.

What is claimed is:

1. A folding knife convenient to carry, comprising: a left handle plate and a right handle plate mutually connected via a fixing element, a blade mounted between the left handle plate and the right handle plate through a pivot, and a leaf spring connected to or integrally formed with the left handle plate or the right handle plate, wherein when the blade is in its open position, the leaf spring retrieves its normal position under the blade and presses its head top surface against a rear end of the blade that an angle A is formed between the head top surface of the leaf spring and the vertical cross surface of the blade, and when the blade is in the folded position, the leaf spring is depressed laterally to move to a predetermined space defined between the left or the right handle plate to the blade, characterized in that: an angle B equal to the angle A is formed between the rear end of the blade and the vertical cross surface to make the rear end of the blade meets the head top surface of the leaf spring, and the rear end of the blade has a knurled surface thereon.

2. The folding knife convenient to carry according to claim 1, wherein the knurled surface of the rear end of the blade is formed in a linear pattern having straight ridges parallel to knife faces.

3. The folding knife convenient to carry according to claim 1, wherein the knurled surface of the rear end of the blade is formed in a diamond-shaped pattern.

4. The folding knife convenient to carry according to claim 1, wherein the knurled surface of the rear end of the blade is formed with a plurality of regular-dispersed dimples.

5. The folding knife convenient to carry according to claim 1, wherein the knurled surface of the rear end of the blade is formed with a plurality of regular-dispersed projections.

6. The folding knife convenient to carry according to claim 1, wherein the head top surface of the leaf spring is formed in a knurled surface.

7. The folding knife convenient to carry according to claim 6, wherein the knurled surface of the head top surface of the leaf spring is formed in a linear pattern having straight ridges parallel to knife faces.

8. The folding knife convenient to carry according to claim 6, wherein the knurled surface of the head top surface of the leaf spring is formed in a diamond-shaped pattern.

9. The folding knife convenient to carry according to claim 6, wherein the knurled surface of the head top surface of the leaf spring is formed with a plurality of regular-dispersed dimples.

10. The folding knife convenient to carry according to claim 6, wherein the knurled surface of the head top surface of the leaf spring is formed with a plurality of regular-dispersed projections.
